(19) United States
(12) Patent Application Publication
(10) Pub. No.: US 2024/0245991 A1
(43) Pub. Date: Jul. 25, 2024

(54) GAME CONTROL METHOD, ELECTRONIC DEVICE, AND COMPUTER-READABLE STORAGE MEDIUM

(71) Applicant: SHANGHAI LILITH TECHNOLOGY CORPORATION, Shanghai (CN)

(72) Inventors: Zhiteng CHEN, Shanghai (CN); Yikun GUO, Shanghai (CN); Zihao WANG, Shanghai (CN); Ye WANG, Shanghai (CN); Lin FENG, Shanghai (CN)

(73) Assignee: SHANGHAI LILITH TECHNOLOGY CORPORATION, Shanghai (CN)

(21) Appl. No.: 18/005,933

(22) PCT Filed: Jun. 24, 2022
(86) PCT No.: PCT/CN2022/101227

§ 371 Date: Jan. 18, 2023

(51) Int. Cl. A63F 13/52; A63F 13/537; A63F 13/55

(52) U.S. Cl. CPC A63F 13/52; A63F 13/537; A63F 13/55

(57) ABSTRACT

Disclosed are a game control method, an electronic device and a computer-readable storage medium. In response to a first operation on an object control in a virtual scene, a virtual object corresponding to the object control is displayed in an object display area in a battle area of the virtual scene, and a skill control is displayed in a control display area where the object control is placed. In response to a second operation on the skill control, an apply range and an indicator of a first target skill corresponding to the skill control are displayed in the battle area, and the virtual object is controlled to apply the first target skill in accordance with the indicator.

### CROSS-REFERENCE TO RELATED DISCLOSURES

This application is a national stage application of PCT international application PCT/CN2022/101227 filed on Jun. 24, 2022, entitled “GAME CONTROL METHOD, ELECTRONIC DEVICE, AND COMPUTER-READABLE STORAGE MEDIUM”, the entire contents of which are incorporated by reference.

### TECHNICAL FIELD

This disclosure relates to the human-computer interaction technology, and in particular, to a game control method, an electronic device and a computer-readable storage medium.

### BACKGROUND

With the development of computer technology and smart terminals, many games based on the smart terminal have appeared, such as popular card games.

At present, a player can select a character control and place a virtual object corresponding to the character control at a target area when playing a card battle game, and the virtual object will perform actions such as moving, attacking, healing, etc., according to preset rules.

### SUMMARY

Embodiments of the present disclosure provide a game control method, an electronic device and a computer-readable storage medium that improve human-machine interaction intelligence.

In a first aspect, embodiments of the present disclosure provide a game control method. The method includes:
displaying, in response to a first operation on an object control in a virtual scene, a virtual object corresponding to the object control in an object display area in a battle area of the virtual scene, and displaying a skill control in a control display area where the object control is placed; and
displaying, in response to a second operation on the skill control, an apply range and an indicator of a first target skill corresponding to the skill control in the battle area, and controlling the virtual object to apply the first target skill in accordance with the indicator, wherein the indicator is configured to indicate an action range of applying the first target skill, and the action range of the first target skill is adjustable based on an operation instruction.

In one of the embodiments, the second operation includes a first trigger operation and a second trigger operation. Displaying, in response to the second operation on the skill control, the apply range and the indicator of the first target skill corresponding to the skill control in the battle area, and controlling the virtual object to apply the first target skill in accordance with the indicator includes: displaying the apply range and the indicator in the battle area in response to the first trigger operation on the skill control, and controlling the virtual object to apply the first target skill in accordance with the indicator in response to the second trigger operation in the battle area.

In one of the embodiments, the first trigger operation includes a dragging operation, and the second trigger operation includes a releasing operation. Displaying the apply range and the indicator in the battle area in response to the first trigger operation on the skill control and controlling the virtual object to apply the first target skill in accordance with the indicator in response to the second trigger operation in the battle area includes:
displaying the apply range in the battle area in response to the dragging operation, gradually reducing the display of the skill control during the dragging operation, and stopping the display of the skill control and displaying the indicator in the battle area when an operation position corresponding to the dragging operation is located within the battle area; and
controlling the virtual object to apply the first target skill in accordance with the indicator in response to the releasing operation.

In one of the embodiments, the indicator includes a circular indicator, a radial indicator, or a sector indicator.

In one of the embodiments, the indicator is the circular indicator if the first target skill is a range-applied skill.

In one of the embodiments, controlling the virtual object to apply the first target skill in accordance with the indicator includes: controlling the virtual object to apply the first target skill to a range indicated by the circular indicator.

In one of the embodiments, the indicator is the radial indicator or the sector indicator if the first target skill is a direction-applied skill.

In one of the embodiments, the radial indicator or the sector indicator extends from a position of the virtual object to an edge of the apply range.

In one of the embodiments, controlling the virtual object to apply the first target skill in accordance with the indicator includes: controlling the virtual object to apply the first target skill to a range indicated by the radial indicator or the sector indicator.

In one of the embodiments, the method further includes marking affected objects corresponding to the first target skill and located in the apply range with a first marker.

In one of the embodiments, the method further includes marking affected objects corresponding to the first target skill and located in a range indicated by the indicator with a second marker.

In one of the embodiments, the controlling the virtual object to apply the first target skill in accordance with the indicator includes: controlling the virtual object to apply the first target skill to the affected objects marked with the second marker.

In one of the embodiments, the method further includes: stopping the display of the apply range and the indicator if determining that an operation position corresponding to the second operation is located outside the battle area.

In one of the embodiments, the method further includes: removing the skill control from the control display area if determining that an operation position corresponding to the second operation is located outside the battle area.

In one of the embodiments, the method further includes: acquiring current battle data. The current battle data includes a set of battle data of the virtual object and a set of battle data of an enemy virtual object corresponding to the virtual object. A proportion of the object display area to the battle area is increased or decreased according to the current battle data.

In one of the embodiments, the method further includes: displaying a resource identifier in the virtual scene. The resource identifier is configured to represent at least one of an upper limit of the resource value, a deducted resource value, or a recovery rate of the resource. The recovery rate of the resource increases with a time length of the current battle, and/or the recovery rate of the resource increases in a target stage of the battle.

In one of the embodiments, the displaying the skill control in the control display area where the object control is placed includes: displaying at least one skill control in the control display area. Displaying, in response to the second operation on the skill control, the apply range and the indicator of the first target skill corresponding to the skill control in the battle area and controlling the virtual object to apply the first target skill in accordance with the indicator includes: obtaining a type of the skill control in response to the second operation on the skill control. If the type of the skill control is determined to be a first type, the apply range and the indicator of the first target skill corresponding to the skill control are displayed in the battle area, and the virtual object is controlled to apply the first target skill in accordance with the indicator. The first type skill control is configured to apply skills to an enemy virtual object or a teammate virtual object corresponding to the virtual object. If the type of the skill control is determined to be a second type, a second target skill corresponding to the second type skill control is applied to the virtual object. The second type skill control is configured to apply skills to the virtual object.

In a second aspect, embodiments of the present disclosure provide an electronic device, which includes one or more memories and one or more processors. One or more programs are stored in the one or more memories. When the one or more programs are executed by the one or more processors, the electronic device is caused to perform steps of the game control method according to any one of the above embodiments of the first aspect.

In a third aspect, embodiments of the present disclosure provide a computer-readable storage medium, on which a computer program is stored. When the computer program is executed by a processor, steps of the game control method according to any one of the embodiments of the first aspect are implemented.

In a fourth aspect, embodiments of the present application provide a computer program product, which includes computer executable instructions. When the instructions are executed by a processor, steps of the game control method as described in any one of the embodiments of the first aspect are implemented.

### BRIEF DESCRIPTION OF THE DRAWINGS

In order to illustrate the technical solutions in the embodiments of the present disclosure or prior art more clearly, the accompanying drawings used in the description of the embodiments or prior art will be briefly introduced below. Apparently, the accompanying drawings in the following description are only some embodiments of the present disclosure. For those of ordinary skill in the art, other drawings can also be derived from these drawings without creative effort.

FIG. 1 is a schematic diagram of an implementation scenario of a game control method according to an embodiment of the present disclosure.

FIG. 2 is a flowchart of a game control method according to an embodiment of the present disclosure.

FIG. 3 is a schematic diagram of a game interface according to an embodiment.

FIG. 4 is a schematic diagram of a game interface according to an embodiment.

FIG. 5 is a schematic diagram of a game interface according to an embodiment.

FIG. 6 is a schematic diagram of a game interface according to an embodiment.

FIG. 7 is a schematic diagram of a game interface according to an embodiment.

FIG. 8 is a flowchart of a game control method according to an embodiment of the present disclosure.

FIG. 9 is a flowchart of a game control method according to an embodiment of the present disclosure.

FIG. 10 is a schematic diagram of a game interface according to an embodiment.

FIG. 11 is a flowchart of a game control method according to an embodiment of the present disclosure.

FIG. 12 is a block diagram of a structure of a game control device according to an embodiment.

FIG. 13 is a block diagram of a structure of a game control device according to an embodiment.

FIG. 14 is a block diagram of a structure of a game control device according to an embodiment.

FIG. 15 is a block diagram of a structure of a game control device according to an embodiment.

FIG. 16 is a block diagram of a structure of a game control device according to an embodiment.

FIG. 17 is a schematic diagram of an internal structure of an electronic device according to an embodiment.

### DETAILED DESCRIPTION OF THE EMBODIMENTS

In order to make the purpose, technical solutions and advantages of the present disclosure clearer and more understandable, the following is a further detailed description of the present application in conjunction with the accompanying drawings and embodiments. It should be understood that the specific embodiments described herein are intended to explain the present disclosure only and are not intended to limit the present disclosure.

It should be understood that the terms “first”, “second”, etc. used in the present disclosure may be used to describe various components, but these components are not limited by these terms. These terms are used only to distinguish a first element from another element. For example, without departing from the scope of this application, a first client may be referred to as a second client, and similarly, a second client may be referred to as a first client. Both the first client and the second client are clients, but they are not the same client.

A card battle game is a game in which players in different teams control virtual objects to battle, capture strongholds or destroy enemy team's strongholds in the virtual scene. For example, in the card battle game, players may be divided into at least two opposing teams. Alternatively, one or more players are grouped into one team, and virtual objects synthesized by Artificial Intelligence (AI) form another team. The different teams compete in a certain virtual scene. Alternatively, the different teams each occupy a corresponding area in a map to compete with certain victory conditions as the goal, etc. The victory conditions include, but not limited to, at least one of capturing strongholds or destroying the enemy team's strongholds, killing the virtual objects of the enemy team, ensuring the own survival in a specified scene and time, capturing certain resources, or a higher interactive score than the rival within a specified time. For example, in the card game, a virtual card character controlled by the player may compete with a virtual object synthesized by a computer device through AI, and the team with the higher interaction score at the end of the game wins.

The virtual scene is displayed when an application is running on a terminal. The virtual scene may be obtained by simulating a real scene using technologies such as AR, VR, etc., or completely fictional, or semi-fictional and semi-simulated. The virtual scene may be two-dimensional or three-dimensional. There is no limitation to the specific configuration and construction of the virtue scene in the embodiments of the present disclosure. The virtual scene may include multiple elements according to the needs of the game. For example, the virtual scene may include a house, a store, a street, a bridge, a tree, a sky, a desert, a castle, a river, etc. The virtual scene may include a battle area in which different players compete. Alternatively, the virtual scene may include multiple battle areas where different players occupy one or more battle areas for competition, respectively. The virtual scene may be constructed according to the actual requirements of the game.

The virtual object may be a virtual character involved in interactions in the virtual scene, e.g., a virtual character controlled by the player involved in the competition, or an AI virtual character involved in the competition. The virtual object may be constructed according to an actual character, e.g., a three-dimensional model constructed according to an actual task image. Alternatively, the virtual object may also be a completely fictitious character such as an anime character, a cartoon character, etc., constructed according to the requirements of the game.

In the current card battle game, the player may materialize the virtual object into the battle area by a selecting card, and then the virtual object will fight automatically in the battle area. In a mode of the battle, the player has a certain upper limit of the battle score, and each card corresponds to a battle score. The player can choose a card with a battle score lower than the upper limit of the battle score. After selecting the card, the battle score corresponding to the selected card is deducted from the player's upper limit of the battle score. The upper limit of the battle score increases or recovers with the time length of the game. The player selects the card and places the card in a target area, and the card appears as an animated or a moving character in the target area.

During the battle, the player performs the action of selecting the card and placing the card in the target area. The virtual object displayed after the character card enters the target area will move, attack and heal according to the preset rules. Therefore, for the character cards, the player can perform very few operations except choosing and deciding the entry time and the initial position, and the player's participation in the whole process of the game is insufficient.

The present disclosure provides a game control method. An implementation scene of the game control method will be described as follow.

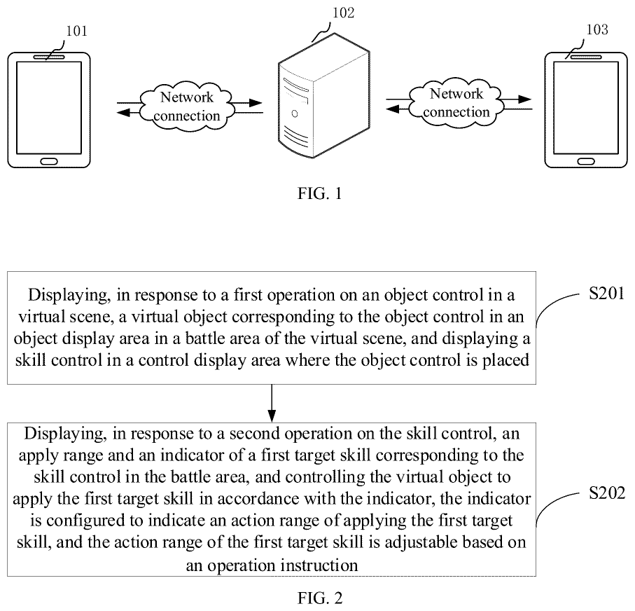

FIG. 1 is a schematic diagram of an implementation scene of the game control method according to an embodiment of the present disclosure. As shown in FIG. 1, the implementation scene may include a first terminal 101 and a server 102. The first terminal 101 and the server 102 are connected through wired or wireless communication. The wireless means may be Bluetooth, Wi-Fi, 3G, 4G, 5G, etc., which are not limited in the embodiments of the present disclosure.

An application supporting the above virtual scene is installed in the first terminal 101. The application may be any one of a Multiplayer Online Battle Arena (MOBA) game, a card battle game, a Massively Multiplayer Online Role Playing Game (MMORPG), a First-Person Shooting game (FPS), a Third-Person Shooting games, a virtual reality application, a three-dimensional map program, a military simulation program, or a multiplayer shooter survival game. The first terminal 101 may be a terminal used by a first player. The first player can control a first virtual object in the virtual scene to perform operations such as crawling, walking, running, riding, jumping, driving, picking up, shooting, attacking, throwing, etc., and can also control the virtual object to apply skills or the like on the first terminal 101.

The server 102 may be a single server, or a server cluster consisting of multiple servers, or a cloud server. The server 102 is configured to provide back-end services for the application supporting the virtual scene. For example, the server 102 can undertake work such as calculating, providing data required for the virtual scene, etc.

In some embodiments, the implementation scene may also include a second terminal 103. The second terminal 103, similar to the first terminal 101, can install and run the application supporting the virtual scene. The second terminal 103 may be a terminal used by a second player. The second player can control a second virtual object in the virtual scene to perform operations such as crawling, walking, running, riding, jumping, driving, picking up, shooting, attacking, throwing, etc., on the second terminal 103, and can also control the second virtual object to apply skills, etc. In some embodiments, the first virtual object controlled by the first terminal 101 and the second virtual object controlled by the second terminal 103 may be hostile and belong to different teams, and battle against each other in a unified battle area. Alternatively, the first virtual object and the second virtual object may be cooperative and belong to a same team, and may battle together.

The first terminal 101 and the second terminal 103 may be a smartphone, a tablet computer, a laptop computer, a desktop computer, a game console, a learning machine, a smartwatch, etc. The first terminal 101 and the second terminal 103 may be of the same type or of different types. The applications installed on the first terminal 101 and the second terminal 103 may be the same, or the application installed on the first terminal 101 and the application installed on the second terminal 103 are applications of the same type for different operating system platforms. The implementation scene may include one or more first terminals 101, and may include one or more second terminals 103, which are not limited in the embodiments of the present disclosure.

FIG. 2 is a flowchart of the game control method according to an embodiment of the present disclosure. The game control method is applied in the first terminal 101 or the second terminal 103. As shown in FIG. 2, the game control method may include the following steps.

At step S201, in response to a first operation on an object control in a virtual scene, a virtual object corresponding to the object control is displayed in an object display area in a battle area of the virtual scene, and a skill control is displayed in a control display area where the object control is placed.

The object control is a trigger control corresponding to the virtual object in the virtual scene. For example, the object control may be a character control. In the virtual scene, multiple character controls may be displayed, and different character controls correspond to different virtual characters. The player can select a desired virtual character by selecting the corresponding character control. For example, in the card battle game, the object control may be a hero card, and different hero cards correspond to different heroes. The object control may display an image, an identification of the virtual object, etc. For example, in the card battle game, the object control may display the hero's image, the hero's name, and so on. The skills, the operations, or the like that the hero has may also be displayed in the virtual scene in the form of text when the object control corresponding to the hero is selected, or a touch operation on the object control corresponding to the hero is detected.

The skill control is a trigger control corresponding to the skill of the virtual object. Each virtual object may include one or more skill controls, and different skill controls correspond to different skills. For example, if the object control is the hero card, the skill control is a skill card corresponding to the corresponding hero. The skill control may also display a pattern, an identification of the skill, etc. The use of the skill, the effect of the skill, and required resource points to use the skill may also be displayed in an interface of the virtual scene in a form of text.

In this embodiment, the terminal loads the virtual scene in response to the player's start operation. The virtual scene may include the object control, the prop control, etc., which are all interaction interfaces for the player. For example, the player can select the virtual object to be controlled through the object control, and select the prop used by the virtual object via the prop control, etc. The object control and the prop control may be buttons in a shape of circle, rectangle, or an irregular shape, etc., suspended in the virtual scene, and may also be patterns, or icons, or the like. Other user interface (UI) controls such as a map control, a store control, etc., may also be displayed in the virtual scene on the terminal. The content of the controls displayed in the virtual scene is not limited in the embodiments of the present disclosure.

As shown in FIG. 3, the virtual scene may include a battle area 301 and a control display area 302. A plurality of card slots 303 may be set in the control display area 302. Different card slots are configured to display different object controls 304. The object controls 304 corresponding to virtual objects respectively are displayed in the card slots 303 of the control display area 302 before any of the virtual objects enters the battle area.

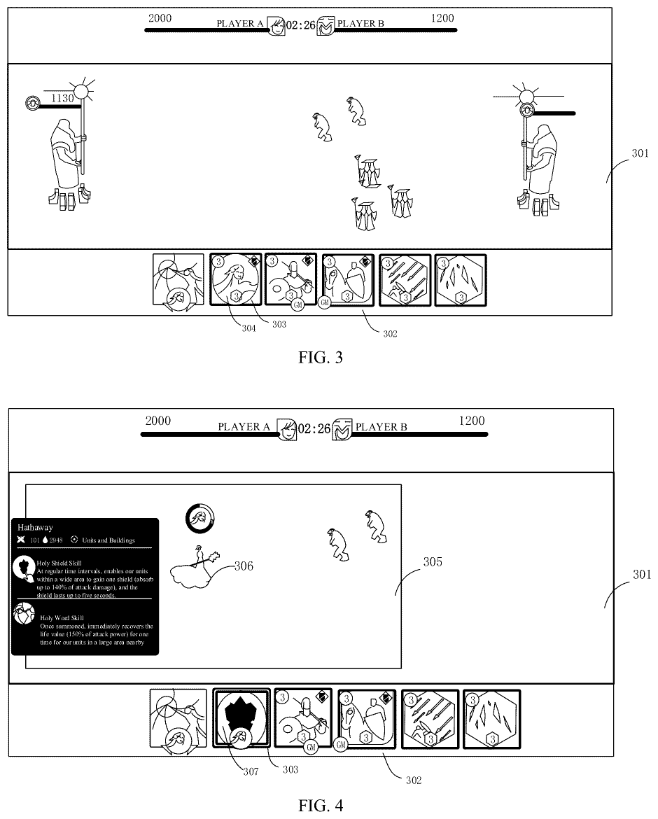

The player can perform the first operation on the corresponding object control when the player wants the virtual object to enter the battle area. In response to the first operation, as shown in FIG. 4, the terminal displays the virtual object 306 corresponding to the object control 304 in the object display area 305 in the battle area 301 of the virtual scene. The first operation may be a click operation, a double-click operation, a dragging operation, etc., and is not limited in the embodiments of the present disclosure. For example, the player can click on the object control, and accordingly the object control is displayed as a selected state. For example, the selected state of the object control may be represented by displaying an aureole at the edge of the object control 304, highlighting the color of the object control, or enlarging or reducing the size of the object control, etc. The terminal displays the virtual object 306 corresponding to the object control in the object display area 305 in the battle area 301 if the player clicks within the object display area 305 in the battle area 301. While the virtual object 306 corresponding to the object control is displayed in the object display area 305, the skill controls of the virtual object are displayed in other card slots in the control display area 302. Alternatively, as shown in FIG. 4, the skill control 307 is displayed in the card slot 303 of the object control 304. Alternatively, the player can drag the object control 304 into the object display area 305, and the object control 304 becomes the virtual object when the object control 304 enters the object display area 305. The virtual object moves with the dragging operation until the dragging operation stops, and the virtual object stops at a corresponding position. Meanwhile, the skill controls of the virtual object are displayed in other card slots of the control display area 302. Alternatively, the skill controls 307 of the virtual object are displayed in the card slots 303 of the object control 304 once the object control 304 moves outside the card slot.

In this embodiment, the skill corresponding to the skill control is a manually applied skill, i.e., the corresponding skill is applied when the player operates on the skill control. For example, after the virtual object enters the battle area, the skill corresponding to the skill control is applied when the player clicks and drags the skill control. Therefore, after the virtual object corresponding to the object control enters the battle area, the skill control of the manually applied skill is displayed in the card slot of the object control. Alternatively, each virtual object may include one manually applied skill, and one skill control is displayed in the card slot of the object control. Alternatively, the virtual object may include multiple manually applied skills, and multiple skill controls are displayed in the card slots of the object control. The multiple skill controls may be of the same size or of different sizes. For example, the skill controls of the skills frequently used by the player may be displayed in an enlarged size, and the skill controls of the skills infrequently used by the player may be displayed in a reduced size according to the player's habits, etc. Alternatively, different skill controls may be displayed sequentially in the slot of the object control according to a certain time period. There is no limitation to the specific display mode of the skill controls.

Alternatively, each virtual object may include a manually applied skill, and may also include an automatically applied skill. The automatically applied skill may be applied according to a predetermined applying rule. As shown in FIG. 4, the holy shield skill is a manually applied skill, and the holy word skill is an automatically applied skill. For example, the automatically applied skill may be applied automatically at a preset time interval, or applied automatically in a particular scene, etc. The automatically applied skill may be applied simultaneously with the manually applied skill. Alternatively, the automatically applied skill may be stopped while the manually applied skill is applied, etc. There is no limitation to the applying rule of the manually applied skill and the automatically applied skill.

Furthermore, in this embodiment, after entering the battle area, the virtual object can perform operations such as walking, running, jumping, attacking, etc., according to a predetermined rule. The virtual object can also perform corresponding operations according to the player's operation, for example, the virtual object moves, jumps, etc., with the player's clicking operation or dragging operation.

At step S202, in response to a second operation on the skill control, an apply range and an indicator of a first target skill corresponding to the skill control are displayed in the battle area, and the virtual object is controlled to apply the first target skill in accordance the indicator. The indicator is configured to indicate an action range of the first target skill when the first target skill is applied. The action range of the first target skill is adjustable based on operation instructions.

The first target skill is the manually applied skill as described above, i.e., the action range of the first target skill can be adjusted based on the operation instructions. For example, the first target skill can follow the player's screen-based movement operation to change the position of the action, the direction of action, etc., so as to adjust the action range of the first target skill.

In this embodiment, the apply range indicates the range in which the skills of the virtual object can be applied. The apply range may be a circle, a rectangle, an oval, etc. The apply range may also be filled with a certain color, or an aureole may be displayed at the edge of the apply range, etc. Taking a circular apply range as an example, the apply range may be a circle with a predetermined radius and with the position of the virtual object as the center, or a circle generated in a predetermined area of the battle area. The form of the indicator is not limited in the embodiments of the present disclosure. In some embodiments, the first target skill can be applied when the virtual object or the indicator is located in the apply range. When the virtual object or the indicator is located outside the apply range, the first target skill cannot be applied, or the first target skill is an invalid skill even if the first target skill is applied.

The indicator indicates the action range of an effect that the virtual object's skill can achieve when the skill is applied. The indicator may be a circle, an oval, a rectangle, a sector, etc., and may also be a radial or a cone. The indicator may also be displayed in a predetermined color. For example, the indicator may be displayed in green, yellow, red, gradient color, etc. The indicator may be located under the virtual object, above the virtual object, or around the virtual object, etc. The form of the indicator is not limited in the embodiments of the present disclosure. In some embodiments, the shape of the indicator may be predetermined or determined according to the type of the first target skill. For example, if the first target skill is a range-applied skill, the indicator may be in a shape such as a circle, an oval, a rectangle, etc., indicating the action range. If the first target skill is a direction-applied skill, the indicator may be in a directional shape such as a radial, a cone, a sector, etc. The form of the indicator is not limited in the embodiments of the present disclosure. The action position of the range-applied skill can be adjusted based on the operation instructions, and the action direction of the direction-applied skill can be adjusted based on the operation instructions.

In this embodiment, the second operation may be a click operation, a double-click operation, a dragging operation, etc. For example, taking the click operation as an example, if the player clicks the skill control, the apply range and the indicator of the first target skill corresponding to the skill control are displayed in the battle area by the terminal, and the first target skill is applied at the position of the indicator or in the direction indicated by the indicator. Alternatively, if the player clicks the skill control, the skill control presents a selected state, and the apply range and the indicator of the first target skill corresponding to the skill control are displayed in the battle area. If the player clicks at any position of the apply range, the first target skill is applied at the position of the indicator or in the direction indicated by the indicator. Alternatively, if the player drags the skill card, the apply range and the indicator of the first target skill corresponding to the skill control are displayed in the battle area. If the player performs a releasing operation, the first target skill is applied at the position of the indicator or in the direction indicated by the indicator, etc. It should be understood that the above exemplary second operations are not limitative.

Furthermore, as the player performs the second operation, the indicator may be changed with the operation position corresponding to the second operation. For example, if the indicator is a circle, the circle moves with the operation position corresponding to the second operation when the operation position corresponding to the second operation is changed, thereby adjusting the action position of the first target skill. If the indicator is a radial indicator, the indication direction of the radial indicator changes with the operation position corresponding to the second operation when the operation position corresponding to the second operation is changed, thereby adjusting the action direction of the first target skill. In sum, the action range of the first target skill is adjustable based on the operation instructions.

As shown in FIG. 5, when the player performs the second operation on the skill control 307, the apply range 501 of the first target skill corresponding to the skill control is displayed in the battle area, while the indicator 502 is displayed under the virtual object. It should be noted that only the circular apply range 501 and the circular indicator 502 in FIG. 5 are illustrated, which, however, does not constitute any limitation to the embodiment of the present disclosure.

Alternatively, in this embodiment, if the first target skill is a range-applied skill and the indicator is outside the apply range, the terminal may output an alert message to remind the player that the operation position is outside the apply range of the first target skill, so as to remind the player to adjust the operation position in time to ensure that the skill can be accurately and effectively applied. For example, the player can change the position of the indicator by touching the screen with the finger. If the actual position of the finger is outside the apply range, a message such as “The current operation position is outside the apply range of the current target skill” may be displayed on the display interface in a form of text, or directly output by voice, or the display displays a specific color. For example, if the indicator is outside the apply range, what is displayed becomes red, orange, etc. In some embodiments, if the first target skill is a direction-applied skill, the direction of the indicator is changed by the player by touching the screen with the finger. If the actual position of the finger is outside the apply range, the virtual object can still apply the first target skill if the actual position of the finger is located within the battle area.

In some embodiments, when applying the first target skill, the virtual object may stay at the current position and apply the target skill to the range indicated by the indicator. Alternatively, the virtual object may move along the range indicated by the indicator to the edge of the apply range, and continuously apply the first target skill during the movement.

Furthermore, the display of the apply range and the indicator is stopped if the operation position corresponding to the second operation is determined to be outside the battle area. In this embodiment, if the terminal detects that the operation position corresponding to the second operation is located outside the battle area, the apply range and the indicator are not displayed in the battle area to remind the player that the operation position corresponding to the second operation is outside the battle area, and the second operation is an invalid operation.

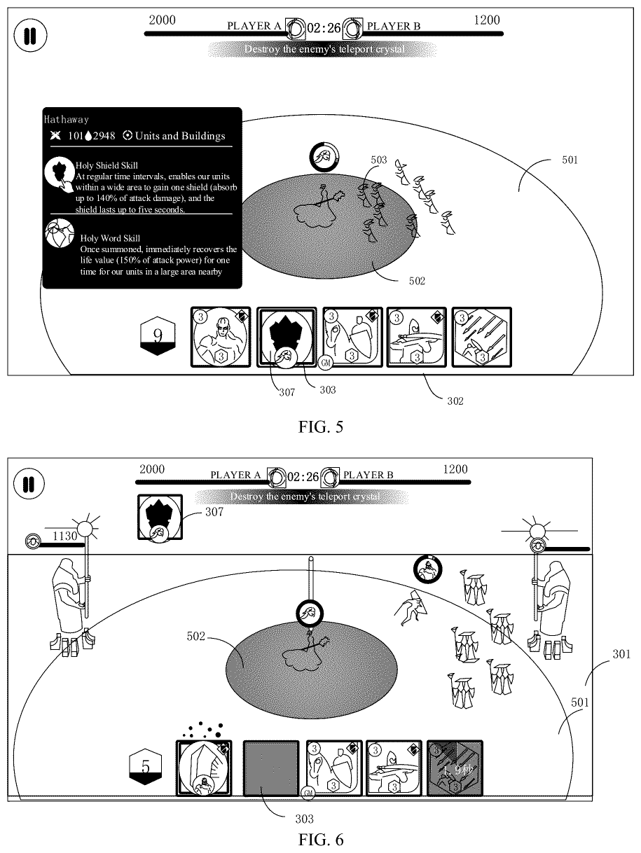

In some embodiments, the skill control is removed from the control display area if the operation position corresponding to the second operation is determined to be located outside the battle area. In this embodiment, if the terminal detects that the operation position corresponding to the second operation is located outside the battle area, the skill control may be removed from the control display area. As shown in FIG. 6, the card slot 303 in the control display area originally configured to display the skill control is empty. Furthermore, the skill control 307 may also be moved and displayed outside the battle area 301, and accordingly, the player cannot use the first target skill.

In the game control method provided in the embodiment of the present disclosure, in response to the first operation on the object control in the virtual scene, the virtual object corresponding to the object control is displayed in the object display area in the battle area of the virtual scene, and the skill control is displayed in the control display area where the object control is placed. In response to the second operation, the apply range and the indicator of the first target skill corresponding to the skill control are displayed in the battle area, and the virtual object is controlled to apply the first target skill in accordance with the indicator. The skill control is displayed in the control display area of the object control after the virtual object enters the battle area, and the action range of the first target skill corresponding to the skill control can be adjusted based on the operation instruction. Therefore, the player can perform the second operation on the skill control to adjust the position or direction of the indicator by the second operation, so as to adjust the action range of the first target skill. After the virtual object enters the battle area, the operations that the player can perform are relatively increased, making the human-computer interaction more intelligent.

In some embodiments, the indicator includes a circular indicator, a radial indicator, or a sector indicator. The circular indicator indicates the action range affected by the effect generated by the first target skill when the first target skill is applied. The circular indicator may be a circle generated with a certain radius with the position of the virtual object as the center. The radius may be determined according to the action range affected by the effect generated during the first target skill is applied. As shown in FIG. 5 and FIG. 6, the circular indicator 502 may be displayed under the feet of the virtual object. Alternatively, the circular indicator may be displayed at other locations, for example, the circular indicator is set under the feet of an enemy character. Alternatively, there is no overlap between the position of the circular indicator and the virtual object, and if a tangent line of the circular indicator is made across the location of the virtual object, a certain angle is formed between the tangent line and a line connecting the circular indicator and the virtual object. The circular indicator may indicate the action range of the first target skill. The circular indicator can move according to the operation instruction of the player. In some embodiments, the first target skill may be applied when the center of the circular indicator is located in the apply range. The first target skill cannot be applied when the center of the circular indicator is outside the apply range. In addition, the circular indicator may be displayed in a specific color to remind the player that the circular indicator is outside the apply range.

In some embodiments, the indicator may also be a triangle, a rectangle, an oval, a sector or other irregular shape, etc. The shape and the color of the indicator, etc. may be set by the developer according to the type and effect of the skill in the game, etc., There is no limitation to the shape and the color of the indicator in the embodiments of the present disclosure.

In some embodiments, the indicator is the circular indicator if the first target skill is the range-applied skill. The step of controlling the virtual object to apply the first target skill in accordance with the indicator includes: controlling the virtual object to apply the first target skill in the range indicated by the circular indicator.

In this embodiment, the circular indicator may be displayed in the battle area if the first target skill is a range-applied skill. The terminal can control the virtual object to apply the first target skill to the range indicated by the circular indicator. As shown in FIG. 5, when the first target skill is applied, all of the affected objects 503 located in the circular indicator 502 will be affected by the effect generated by the first target skill, so that the first target skill can be applied toward multiple affected objects 503 at one time.

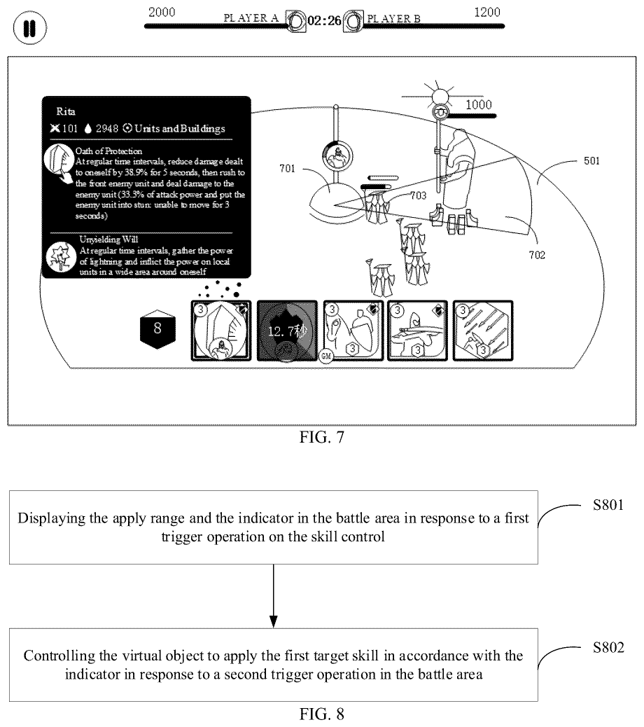

In this embodiment, the radial indicator indicates the action range of the first target skill when the first target skill is applied. All of the affected objects located on the radial indicator and in the direction indicated by the radial indicator are affected by the effect of the first target skill. The sector indicator may indicate the action range of the first target skill when the first target skill is applied. In some embodiments, the radial indicator or the sector indicator extends from the location of the virtual object to the edge of the apply range. The radial indicator or the sector indicator may start at the location of the virtual object, and extend to the edge of the apply range in a predetermined direction or in the direction according to the player's operation instructions, such as the sector indicator 702 shown in FIG. 7. Taking the card battle game as an example, the radial indicator or the sector indicator may start at the location of the hero character's feet, and extend to the edge of the apply range in a direction of the virtual object of the enemy player. Alternatively, the radial indicator or the sector indicator may start at the location of the hero character's feet, and extend to the edge of the apply range toward the location of the player's click in the battle area, etc.

In some embodiments, the indicator is the radial indicator or the sector indicator if the first target skill is a direction-applied skill. Furthermore, the step of controlling the virtual object to apply the first target skill in accordance with the indicator includes: controlling the virtual object to apply the first target skill in the range indicated by the radial indicator or the sector indicator.

In this embodiment, the radial indicator or the sector indicator is displayed in the battle area if the first target skill is a direction-applied skill. The terminal can control the virtual object to apply the first target skill to the range indicated by the radial indicator or the sector indicator. Taking the card battle game as an example, as shown in FIG. 7, the hero character 701 can apply the first target skill into the range indicated by the sector indicator 702, and the enemy characters 703 located in the sector indicator 702 and in the direction indicated by the sector indicator 702 will be attacked by the first target skill. Moreover, the direction of the radial indicator or the sector indicator may move according to the movement of the operation position corresponding to the operation instruction of the player.

In this embodiment, the indicator may be displayed on the screen of the terminal when the virtual object is controlled to apply the first target skill, and the effect of the first target skill is displayed in the range of the indicator and/or in the direction indicated by the indicator. Alternatively, the indicator is displayed when the skill control is triggered. When the virtual object is controlled to apply the first target skill, the indicator is no longer displayed on the screen of the terminal, and only the effect of the first target skill is displayed in the range of the indicator and/or in the direction indicated by the indicator, there is no limitation to the display of the indicator in the embodiments of the present disclosure.

In the embodiments of the present disclosure, the indicator may be the circular indicator, the radial indicator or the sector indicator, etc. Different shapes of the indicators may be displayed corresponding to different types of the first target skills respectively. In the development stage, the shape of the indicator may be flexibly set according to the game effect, the skill type, etc., making the display effect of the game interface more diverse and interesting. Moreover, the position, and the direction of the indicator, etc., may be changed with the position of the player's screen-based operation instructions, increasing the player's participation and further improving the intelligence of human-computer interaction.

In the embodiment shown in FIG. 2, the second operation may be performed in multiple ways. Different second operation ways that apply the first target skill will be described below.

In a first case, the second operation includes a first trigger operation and a second trigger operation. As shown in FIG. 8, “in response to a second operation on the skill control, an apply range and an indicator of a first target skill corresponding to the skill control are displayed in the battle area, and the virtual object is controlled to apply the first target skill in accordance with the indicator” in the step S202 may include the following steps S801 and S802.

At step S801, the apply range and the indicator are displayed in the battle area in response to the first trigger operation on the skill control.

In this embodiment, the first trigger operation may be a click, a double-click, a long press, etc. For example, the terminal displays the apply range in the battle area and displays the indicator based on the location of the virtual object when the player performs the click, the double-click, or the long-press operation on the skill control. In a card battle game, for instance, the skill control is a skill card, and the virtual object is the hero character corresponding to the character card. As shown in FIG. 5, when the skill card 307 is clicked, a circular apply range 501 is displayed in the battle area, and a circular indicator 502 is displayed under the feet of the hero character. Alternatively, as shown in FIG. 7, when the skill card is clicked, the circular apply range 501 is displayed in the battle area, and the sector indicator 702 is displayed under the feet of the hero character 701.

At step S802, the virtual object is controlled to apply the first target skill in accordance with the indicator in response to the second trigger operation in the battle area.

In this embodiment, the second trigger operation may be a click, a double click, a long press, etc. For example, the virtual object is controlled to apply the first target skill in accordance with the indicator when the player performs the operation such as the click, the double click, the long press, etc. in the battle area. Continuing with the card battle game example, when the apply range and the indicator are displayed in the battle area, if the player clicks at any position within the apply range of the battle area, the hero character can apply the first target skill to an enemy character within the range of the indicator or to an enemy character indicated by the indicator.

When the player performs the second trigger operation in the battle area, the position of the indicator and/or the direction of the indicator may be changed with the position corresponding to the second trigger operation. In other words, the player can adjust the position and/or the direction of the indicator by the second trigger operation, so as to adjust the action range of the first target skill, such that the effect of the first target skill can better meet the player's requirements.

In the game control method provided by the embodiments of the present disclosure, the apply range and the indicator are displayed in the battle area in response to the first trigger operation on the skill control. The virtual object is controlled to apply the first target skill in accordance with the indicator in response to the second trigger operation in the battle area. The player can accurately adjust the position and/or the direction of the indicator by the second trigger operation according to the skill applying demand, so as to adjust the action range of the first target skill. Therefore, the effect of the first target skill can better meet the player's requirements, and the player's participation is improved.

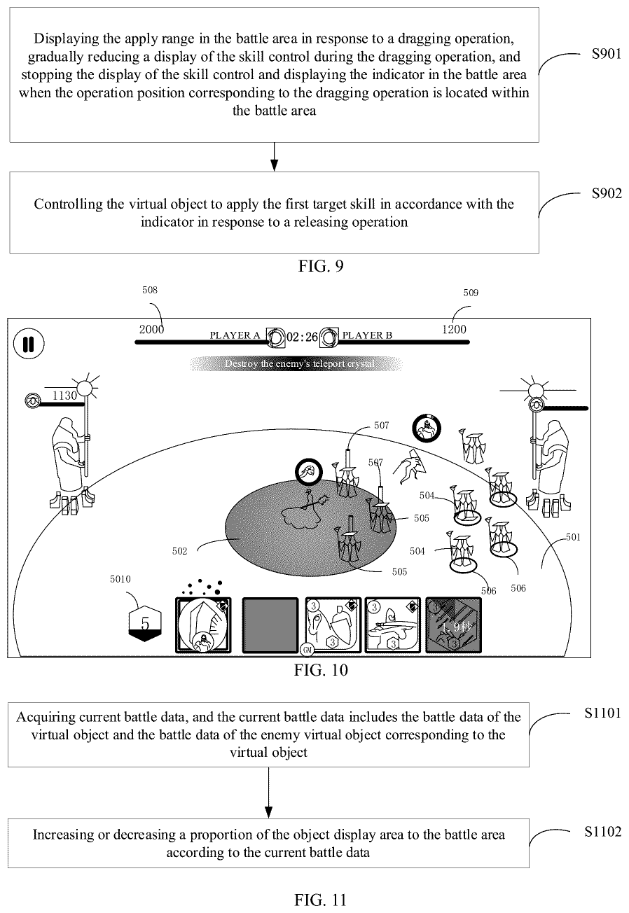

In a second case, the second operation includes the first trigger operation and the second trigger operation. The first trigger operation includes a dragging operation. The second trigger operation includes a releasing operation. As shown in FIG. 9, the step of displaying the apply range and the indicator in the battle area in response to the first trigger operation on the skill control, and controlling the virtual object to apply the first target skill in accordance with the indicator in response to the second trigger operation in the battle area includes the following steps S901 and S902.

At step S901, the apply range is displayed in the battle area in response to the dragging operation, the displayed skill control is gradually reduced during the dragging operation, and the skill control is stopped from being displayed and the indicator is displayed in the battle area when the operation position corresponding to the dragging operation is located within the battle area.

In this embodiment, the player may directly drag the skill control. The apply range is displayed in the battle area when the skill control is clicked. The apply range is continuously displayed in the battle area while the skill control is being dragged, and the skill control is gradually reduced while the skill control is being dragged. The indicator is displayed when the operation position corresponding to the dragging operation is located within the battle area.

Exemplarily, the skill control is reduced in a predetermined size reduction ratio during the dragging operation. When the operation position corresponding to the dragging operation is located within the battle area, the skill control is no longer displayed, and the indicator is displayed at the operation position corresponding to the dragging operation. Alternatively, the skill control is reduced in a certain size reduction ratio according to a moving speed of the operation position corresponding to the dragging operation. The faster the operation position moves, the faster the size of the skill control is reduced. The slower the operation position moves, the slower the size of the skill control is reduced.

In some embodiments, during the dragging operation, the indicator may change with the change of the operation position corresponding to the dragging operation. For example, if the indicator is a circular indicator, the circular indicator moves with the movement of the operation position corresponding to the dragging operation. If the indicator is the radial indicator or the sector indicator, the direction of the radial indicator or the sector indicator changes with the change of the operation position corresponding to the dragging operation. Therefore, the player can flexibly adjust the position and/or the direction of the indicator during the execution of the dragging operation, so as to adjust the apply range of the first target skill.

At step S902, the virtual object is controlled to apply the first target skill in accordance with the indicator in response to the releasing operation.

In this embodiment, the virtual object is controlled to apply the first target skill in accordance with the indicator when a releasing operation is detected. For example, during the dragging operation, the virtual object is controlled to apply the first target skill in accordance with the indicator when the terminal detects that the player's finger moves away from the touch screen or the button of the mouse is released.

If the indicator is a circular indicator, the circular indicator will move as the operation position corresponding to the dragging operation moves. In general, the operation position corresponding to the releasing operation is the current center of the circular indicator. The terminal controls the virtual object to apply the first target skill to the range indicated by the circular indicator, and all the objects located within the circular indicator will be affected by the effect of the first target skill. If the indicator is a radial indicator or a sector indicator, the start position of the radial indicator or the sector indicator may be unchanged during the dragging operation. For example, the start position of the radial indicator or the sector indicator is always under the feet of the virtual object, but the direction of the radial indicator or the sector indicator changes with the operation position corresponding to the dragging operation. When the releasing operation is detected, the direction of the radial indicator or the sector indicator is from the virtual object's feet to the operation position corresponding to the releasing operation, and the virtual object is controlled to apply the first target skill to the range indicated by the radial indicator or the sector indicator. The objects located on the line of the radial indicator, the objects located in the sector indicator, and the objects located in the direction indicated by the radial indicator or the sector indicator are all affected by the effect of the first target skill.

In the game control method provided by the embodiments of the present disclosure, the apply range is displayed in the battle area in response to the dragging operation on the skill control. The displayed skill control is gradually reduced during the dragging operation. The indicator is displayed when the operation position corresponding to the dragging operation is located within the battle area. Therefore, the interest of the display interface is improved. The virtual object is controlled to apply the first target skill in accordance with the indicator in response to the releasing operation on the skill control, thus the player can flexibly adjust the action range of the indicator by the dragging operation and the releasing operation. Moreover, the change of the display effect of the indicator is more intuitive and operable, which improves the player's experience.

Furthermore, in any of the above embodiments, in order to intuitively represent the effect of the first target skill, the affected objects in the apply range and/or in the range indicated by the indicator may be marked. The affected objects may be determined according to the function of the first target skill. For example, if the first target skill is an attacking skill with respect to the enemy, the virtual objects of the enemy players in the apply range and/or in the range indicated by the indicator may be marked. If the first target skill is a healing skill or a supporting skill with respect to the teammate, the virtual objects of the own team in the apply range and/or in the range indicated by the indicator may be marked. There is no limitation to the specific marked object in the embodiment of the present disclosure.

In some embodiments, a first marker is displayed on the affected objects corresponding to the first target skill in the apply range.

In this embodiment, if the terminal detects that there are affected objects corresponding to the first target skill in the apply range, the first marker is displayed on the affected objects corresponding to the first target skill located in the apply range. The first marker may be an aureole, a light column, etc., on the affected object. The first marker may also be a change of the color of the affected object, or the size of the affected object, etc. As shown in FIG. 10, the first marker is the aureole. The aureole 506 is displayed in the projection area under each affected object 504 corresponding to the first target skill located in the apply range. In other words, the aureole is displayed under the feet of the enemy player's virtual object.

In some embodiments, a second marker is displayed on the affected objects corresponding to the first target skill in the range indicated by the indicator.

In this embodiment, if the terminal detects that there are affected objects corresponding to the first target skill in the range indicated to by the indicator, the second marker is displayed on the affected objects corresponding to the first target skill in the range indicated to by the indicator. The second marker may also be an aureole, a light column, etc., based on the affected object. The second marker may also be a change of the color of the affected object, the size of the affected object, etc. As shown in FIG. 10, the second marker is the light column. The light column 507 is displayed on each affected object 505 corresponding to the first target skill located in the range indicated by the indicator 502. For example, the light column may be displayed on the head of the affected object. Alternatively, the light column may extend through the affected object.

It should be noted that the first markers may be displayed simultaneously on the affected objects corresponding to the first target skill in the range indicated by the indicator, or the second markers may be displayed simultaneously on the affected objects corresponding to the first target skill in the range indicated by the indicator. Alternatively, the first markers and the second markers may be displayed simultaneously on the affected objects corresponding to the first target skill in the range indicated by the indicator. In general, when the first markers and the second markers are displayed simultaneously on the affected objects, the display effect or the display mode of the first markers is different from that of the second markers.

Furthermore, the step of controlling the virtual object to apply the first target skill in accordance with the indicator includes: controlling the virtual object to apply the first target skill to the affected objects marked with the second marker.

In this embodiment, when the second marker is displayed on each affected object corresponding to the first target skill located in the range indicated by the indicator, the terminal can control the virtual object to apply the first target skill to each of the affected objects displayed with the second marker. As shown in FIG. 10, the virtual object can be controlled to apply the first target skill to the affected objects 505 displayed with the light column 507 overhead, so that the first target skill can be applied more accurately, and the effect of the first target skill can be guaranteed.

In the game control method provided by the embodiments of the present disclosure, the first marker is displayed on the affected objects corresponding to the first target skill located in the apply range, and the second marker is displayed on the affected objects corresponding to the first target skill located in the range indicated by the indicator. The virtual object is controlled to apply the first target skill to the affected objects displayed with the second marker. By marking the affected objects corresponding to the first target skill, the effect of applying the first target skill can be presented more intuitively, improving the applying effect and the accuracy of the effect of the first target skill, and improving the interest of the game.

In the embodiment of the present disclosure, the virtual object corresponding to the object control may have multiple manually applied skills, and therefore, the step of displaying the skill control in the control display area where the object control is placed includes: displaying at least one skill control in the control display area.

In this embodiment, one skill control may be displayed in the control display area if the virtual object has one manually applied skill. Multiple skill controls may be displayed in the control display area if the virtual object has multiple manually applied skills. The display of multiple skill controls may be referred to the embodiment shown in FIG. 2 and will not be repeated here.

Furthermore, the step S202 of displaying the apply range and the indicator of the first target skill corresponding to the skill control in the battle area in response to the second operation on the skill control, and controlling the virtual object to apply the first target skill in accordance with the indicator includes: acquiring a type of the skill control in response to the second operation on the skill control, displaying the apply range and the indicator of the first target skill corresponding to the skill control in the battle area if the skill control is determined to be a first type skill control, and controlling the virtual object to apply the first target skill in accordance with the indicator. The first type skill control is configured to apply the first target skill to the enemy virtual object or the teammate virtual object corresponding to the virtual object.

In this embodiment, the skill corresponding to the skill control may be a skill applied to the enemy virtual object corresponding to the virtual object, and may also be a skill applied to the virtual object itself. The first target skill is a skill applied to the enemy virtual object or the teammate virtual object corresponding to the virtual object. For example, the first target skill may be attacking, defending, killing, implementing a reducing effect, healing, implementing a gaining effect, etc. The enemy virtual object is the enemy player's virtual object, i.e., the first type skill control can be configured to apply skills to the enemy player's virtual object. Alternatively, the enemy virtual object may also be an object to be attacked for competition by the virtual object in the virtual scene. For example, the enemy virtual object may also be the enemy's castle, crystal, etc. The teammate virtual object is the virtual object on the player's own side, which may be the virtual object controlled by the player or the virtual object controlled by the teammate player. In other words, the first type skill control can be configured to apply skills to the virtual object of the player's own side. Alternatively, the teammate virtual object may also be the object that competes together with the virtual object in the virtual scene. For example, the teammate virtual object may also be a soldier, a chariot, etc. The quantity of the enemy virtual object or the teammate virtual object may be one or more, and is not limited in the embodiments of the disclosure.

In the embodiment of the present disclosure, when the second operation of the player on the skill control is detected, the type of the skill control can be determined according to the skill identifier of the skill control, or the position of the skill control in the control display area, etc. If the type of the skill control is determined to be the first type, i.e., the skill to be applied to the enemy virtual object or the teammate virtual object, the apply range and the indicator of the first target skill corresponding to the skill control are displayed in the battle area, and the virtual object is controlled to apply the first target skill to the enemy virtual object or the teammate virtual object in the range indicated by the indicator. If the type of the skill control is determined to be the second type, the second target skill corresponding to the second type skill control is applied to the virtual object. The second type skill control is configured to apply the skill to the virtual object.

The second target skill can be applied to the virtual object itself, in other words, the second target skill is a skill applied to the virtual object itself controlled by the player. For example, the skills corresponding to the second type skill control may be healing, implementing gain effects, etc.

In this embodiment, the skill control is determined to be the second type, i.e., the skill for the virtue object itself, if the second operation on the skill control is detected and the virtual object is thus controlled to apply the second target skill to itself.

In some embodiments, if the type of the skill control is determined to be the second type, the apply range and the indicator may be displayed in the battle area, or the apply range and the indicator may not be displayed. There is no limitation to the display of the apply range and the indicator. In some embodiments, if the type of the skill control is determined to be the second type, the first marker and the second marker may be displayed on the virtual object. For example, a light column is displayed on the head of the virtual object, or an aureole is displayed under the feet of the virtual object, etc.

In the game control method provided by the embodiment of the disclosure, the type of the skill control is obtained in response to the second operation on the skill control. If the type of the skill control is determined to be the first type, the apply range and the indicator of the first target skill corresponding to the skill control are displayed in the battle area, and the virtual object is controlled to apply the first target skill in accordance with the indicator. If the type of the skill control is determined to be the second type, the second target skill corresponding to the second type skill control is applied to the virtual object. The second type skill control is configured to apply skills to the virtual object. In other words, in the embodiments of the disclosure, the virtual object may not only be controlled to apply the skills to the virtual object of the enemy player, but also to apply the skills to the virtual object itself controlled by the player. Therefore, the scene applicability of the skill control is increased, the interaction of the players is improved and the game is more interesting.

Furthermore, in the game control method provided by the embodiment of the present disclosure, the area of the object display area may be adjusted according to battle data. As shown in FIG. 11, the game control method further includes the following steps.

At step S1101, the current battle data is acquired. The current battle data includes the battle data of the virtual object and the battle data of the enemy virtual object corresponding to the virtual object.

The battle data of the virtual object includes the battle data of the virtual object accumulated from the beginning of the game to the current moment during the competition. For example, the battle data may be the accumulated points of the virtual object during the competition. The accumulated points may be obtained by subtracting the lost point values from the point values gained by the virtual object during the battle. Similarly, the battle data of the enemy virtual object corresponding to the virtual object may be obtained by subtracting the lost point values from the point values gained by the enemy virtual object during the battle.

In this embodiment, the current battle data may be obtained according to the accumulated points of the virtual object and the accumulated points of the enemy virtual object during the battle. Furthermore, the current battle data may be displayed in the battle area. As shown in FIG. 10, the point value 508 of the virtual object and the point value 509 of the enemy virtual object are displayed on top of the battle area.

At step S1102, the proportion of the object display area to the battle area is increased or decreased according to the current battle data.

In this embodiment, the proportion of the object display area to the battle area may be adjusted according to the battle data of the virtual object and the enemy virtual object. For example, the proportion of the object display area to the battle area is increased if the accumulated points of the virtual object are greater than the accumulated points of the enemy virtual object. The proportion of the object display area to the battle area is decreased if the accumulated points of the virtual object are less than the accumulated points of the enemy virtual object. Alternatively, the proportion of the object display area to the battle area may also be adjusted according to the ratio of the accumulated points of the virtual object to the accumulated points of the enemy virtual object.

In some embodiments, a resource identifier of the player is displayed in the virtual scene. The resource identifier may be configured to represent at least one of an upper limit of the resource value of the player, a deducted resource value corresponding to various operations of the player during the battle, or a recovery rate of the resource. The recovery rate of the resource increases with the time length of the current battle, and/or the recovery rate of the resource increases in a target stage of the battle.

The resource may be a resource allocated to the player by the game, or a resource that the player receives as a reward for winning a battle, or a resource that the player receives for performing a competition during the battle, etc. Corresponding resource values will be consumed when the player uses the virtual object for the battle or operates the virtual object to apply skills during the battle. Since the player's resource value is limited and it takes a certain time to recover the resources, the player needs to review the battle situation to dynamically decide the virtual object and the skill to be used, thus greatly increasing the player's participation and the playability of the game.

In this embodiment, the resource identifier of the player may be displayed in the virtual scene. The resource identifier may be displayed as a pattern, a number, etc. As shown in FIG. 10, a crystal pattern 5010 may be displayed on the left side of the control display area in the virtual scene, and the crystal pattern 5010 is the resource identifier. The color of the crystal pattern 5010 may be displayed in a gradient color from the bottom to the top, with different color ratios representing different resource values. The number displayed in the crystal pattern represents the current resource value owned by the player.

The player's resource value is deducted by the corresponding value when the skill control and the object control are triggered. As the duration of the game increases, the player's resource value increases as the virtual object gains the resource value during the battle. The longer the current battle time is, the faster the resource value increases, and/or the resource value increases faster during a target stage of the battle. For example, the recovery speed of the resource becomes faster during the stages of capturing a bunker, winning energy crystals, gaining a lot of points for an action, etc.

In the game control method provided by the embodiment of the present disclosure, the current battle data is acquired. The proportion of the object display area to the battle area is increased or decreased according to the current battle data, and the action area of the virtual object in the battle area can be changed accordingly. Therefore, the current situation of the battle can be presented to the player visually, providing timely feedback to the player. Moreover, the resource identifier of the virtual object may be displayed in the virtual scene during the battle, so that the player can pay attention to their own resources in time to adjust tactics, etc. Therefore, the human-computer interaction is more intelligent, which meets the needs of the player and improves the player's experience.

It should be understood that, although the individual steps in the flowcharts of FIGS. 2-11 are shown sequentially by the indications of the arrows, the steps are not necessarily executed sequentially in the order indicated by the arrows. Unless explicitly stated herein, the execution of these steps is not strictly limited to the order, and the steps may be executed in other orders. Moreover, at least a part of the steps in FIGS. 2-11 may include multiple sub-steps or multiple phases. The multiple sub-steps or multiple phases are not necessarily performed at the same time, but may be performed at different times. The execution order of these steps or stages is not necessarily sequential, but may be performed alternately or in turn with other steps or at least a part of the steps or stages of the other steps.

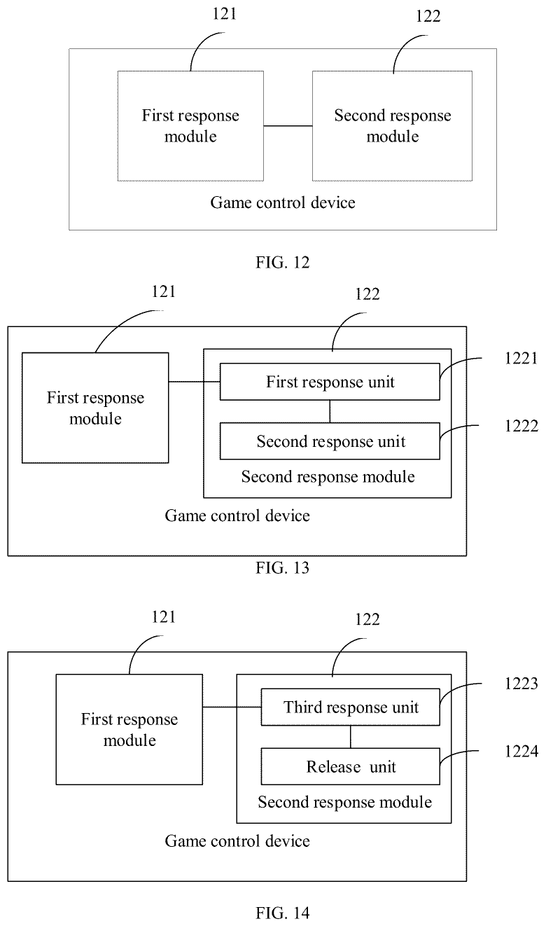

FIG. 12 is a block diagram of a structure of a game control device according to an embodiment. As shown in FIG. 12, the game control device includes a first response module 121 and a second response module 122.

The first response module 121 is configured to display, in response to a first operation on an object control in a virtual scene, a virtual object corresponding to the object control in an object display area in a battle area of a virtual scene, and display a skill control in a control display area where the object control is placed.

The second response module 122 is configured to display, in response to a second operation on the skill control, an apply range and an indicator of a first target skill corresponding to the skill control in the battle area, and control the virtual object to apply the first target skill in accordance with the indicator. The indicator is configured to indicate an action range of the first target skill when the first target skill is applied. The action range of the first target skill is adjustable based on operation instructions.

In one of the embodiments, the second operation includes a first trigger operation and a second trigger operation. As shown in FIG. 13, the second response module 122 includes a first response unit 1221 and a second response unit 1221.

The first response unit 1221 is configured to display the apply range and the indicator in the battle area in response to the first trigger operation on the skill control.

The second response unit 1222 is configured to control the virtual object to apply the first target skill in accordance with the indicator in response to the second trigger operation in the battle area.

In one of the embodiments, the first trigger operation includes a dragging operation, and the second operation includes a releasing operation. As shown in FIG. 14, the second response module 122 includes a third response unit 1223 and a release unit 1224.

The third response unit 1223 is configured to display the apply range in the battle area in response to the dragging operation, gradually reduce the displayed skill control during the dragging operation, stop displaying the skill control and display the indicator in the battle area when the operation position corresponding to the dragging operation is located within the battle area.

The release unit 1224 is configured to control the virtual object to apply the first target skill in accordance with the indicator in response to the releasing operation.

In one of the embodiments, the indicator includes a circular indicator, a radial indicator, or a sector indicator.

In one of the embodiments, the indicator is the circular indicator if the first target skill is a range-applied skill.

In one of the embodiments, the second response module 122 is configured to control the virtual object to apply the first target skill to the range indicated by the circular indicator.

In one of the embodiments, the indicator is the radial indicator or the sector indicator if the first target skill is a direction-applied skill.

In one of the embodiments, the radial indicator or the sector indicator extends from the position of the virtual object to the edge of the apply range.

In one of the embodiments, the second response module 122 is configured to control the virtual object to apply the first target skill to the range indicated by the radial indicator or the sector indicator.

In one of the embodiments, the second response module 122 is further configured to mark the affected objects corresponding to the first target skill and located in the apply range with a first marker.

In one of the embodiments, the second response module 122 is further configured to mark the affected objects corresponding to the first target skill and located in the range indicated by the indicator with a second marker.

In one of the embodiments, the second response module 122 is configured to control the virtual object to apply the first target skill to the affected objects marked with the second marker.

In one of the embodiments, the second response module 122 is further configured to stop displaying the apply range and the indicator if determining that the operation position corresponding to the second operation is located outside the battle area.

In one of the embodiments, the second response module 122 is further configured to remove the skill control from the control display area if determining that the operation location corresponding to the second operation is located outside the battle area.

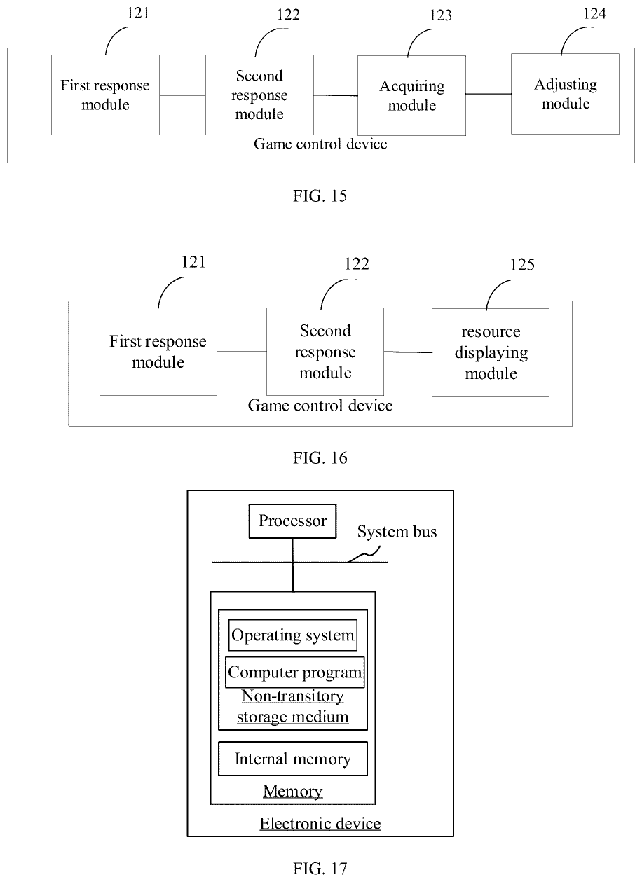

In one of the embodiments, as shown in FIG. 15, the game control device further includes an acquiring module 123, and an adjusting module 124.

The acquiring module 123 is configured to acquire current battle data. The current battle data includes the battle data of the virtual object and the battle data of the enemy virtual object corresponding to the virtual object.

The adjusting module 124 is configured to increase or decrease the proportion of the object display area to the battle area according to the current battle data.

In one of the embodiments, as shown in FIG. 16, the game control device further includes a resource displaying module 125.

The resource displaying module 125 is configured to display a resource identifier in the virtual scene. The resource identifier is configured to represent at least one of an upper limit of the resource value, a deducted resource value, or a recovery rate of the resource. The recovery rate of the resource increases with the time length of the current battle, and/or the recovery rate of the resource increases in a target stage of the battle.

In one of the embodiments, the first response module 121 is configured to display at least one skill control in the control display area.

The second response module 122 is configured to obtain a type of the skill control in response to the second operation on the skill control. If type of the skill control is determined to be a first type, the second response module 122 displays the apply range and the indicator of the first target skill corresponding to the skill control in the battle area, and controls the virtual object to apply the first target skill in accordance with the indicator. The first type skill control is configured to apply skills to the enemy virtual object or the teammate virtual object corresponding to the virtual object. If the type of the skill control is determined to be a second type, the second target skill corresponding to the second type skill control is applied to the virtual object. The second type skill control is configured to apply skills to the virtual object.

The principle and beneficial effects of the game control device can be referred to the description of the game control method in the aforementioned embodiments, and will not be repeated here.

The division of the modules of the game control device is for illustration only. In other embodiments, the game control device may be divided into different modules as needed to complete all or part of the functions of the game control device.

The specific features of the game control device may be referred to the features of the game control method as described above, and will not be repeated here. The modules of the game control device may be implemented in whole or in part by software, hardware, and combinations thereof. Each of the above modules may be embedded in or independent of a processor in a computer device in a form of hardware, or may be stored in a memory of the computer device in a form of software, so that the processor may be called to perform the operations corresponding to the above modules.

An embodiment of the present disclosure further provides an electronic device. The electronic device includes a one or more memories and one or more processors. One or more programs are stored in the one or more memories. When the one or more programs are executed by the one or more processors, the electronic device performs the steps of the game control method described in any of the above embodiments.

FIG. 17 is a schematic diagram of an internal structure of the electronic device according to an embodiment. The electronic device may be any terminal device such as a cell phone, a tablet, a laptop, a desktop computer, a Personal Digital Assistant (PDA), a Point of Sales (POS), an on-board computer, a wearable device, etc. The electronic device includes the processor and the memory connected via a system bus. The processor may include one or more processing units. The processor may be a Central Processing Unit (CPU) or a DSP (Digital Signal Processing), etc. The memory may include a non-transitory storage medium and an internal memory. The non-transitory storage medium stores an operating system and a computer program. The computer program may be executed by the processor to implement the game control method provided in each of the embodiments. The internal memory provides a high-speed caching operation environment for the operating system and the computer program in the non-transitory storage medium.

An embodiment of the present disclosure further provides a computer-readable storage medium. One or more non-transitory computer-readable storage medium includes computer-executable instructions. When the computer-executable instructions are executed by one or more processors, the processors perform the steps of the game control method.

An embodiment of the present disclosure further provides a computer program product including instructions, When the computer program product is run on a computer, the computer executes the game control method.

Any reference to a memory, a storage, a database, or other medium as used herein may include non-transitory and/or transitory memory. The non-transitory memory can include a read-only memory (ROM), a programmable read-only memory (PROM), an erasable programmable read-only memory (EPROM), an electrically erasable programmable read-only memory (EEPROM), or a flash memory. The transitory memory may include a random access memory (RAM), which is used as an external cache memory. By way of illustration and not limitation, RAM is available in various forms, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), sync link dynamic random access memory (SLDRAM), rambus dynamic random access memory (RDRAM), direct rambus dynamic random access memory (DRDRAM).

In the game control method, the electronic device, and the computer-readable storage medium provided by the embodiments of the present disclosure, in response to the first operation on the object control in the virtual scene, the virtual object corresponding to the object control is displayed in the object display area in the battle area of the virtual scene, and the skill control is displayed in the control display area where the object control is placed. In response to the second operation on the object control, the apply range and the indicator of the first target skill corresponding to the skill control in the battle area, and the virtual object is controlled to apply the first target skill in accordance with the indicator. Since the skill control is displayed in the control display area of the object control after the virtual object enters the battle area, and the first target skill corresponding to the skill control is capable of adjusting the action range based on operation instructions, the player can perform the second operation on the skill control in order to adjust the position or direction of the indicator by the second operation, so as to adjust the action range of the first target skill. The player can perform relatively more operations when the virtual object enters the game, thus increasing the player's participation in the game.

The above-mentioned embodiments only illustrate several embodiments of the present disclosure, and the descriptions thereof are relatively specific and detailed, but should not be construed as a limitation on the scope of the patent of the present disclosure. It should be noted that for those skilled in the art, without departing from the concept of the present disclosure, several modifications and improvements can be made, which all fall within the protection scope of the present disclosure. Therefore, the scope of protection of the present disclosure shall be subject to the appended claims.

1. A game control method, comprising:
displaying, in response to a first operation on an object control in a virtual scene, a virtual object corresponding to the object control in an object display area in a battle area of the virtual scene, and displaying a skill control in a control display area where the object control is placed; and
displaying, in response to a second operation on the skill control, an apply range and an indicator of a first target skill corresponding to the skill control in the battle area, and controlling the virtual object to apply the first target skill in accordance with the indicator, wherein the indicator is configured to indicate an action range of applying the first target skill, and the action range of the first target skill is adjustable based on an operation instruction.

2. The method according to claim 1, wherein the second operation comprises a first trigger operation and a second trigger operation, wherein the displaying, in response to the second operation on the skill control, the apply range and the indicator of the first target skill corresponding to the skill control in the battle area, and controlling the virtual object to apply the first target skill in accordance with the indicator comprises:
displaying the apply range and the indicator in the battle area in response to the first trigger operation on the skill control; and
controlling the virtual object to apply the first target skill in accordance with the indicator in response to the second trigger operation in the battle area.

3. The method according to claim 2, wherein the first trigger operation comprises a dragging operation, and the second trigger operation comprises a releasing operation, wherein the displaying the apply range and the indicator in the battle area in response to the first trigger operation on the skill control, and controlling the virtual object to apply the first target skill in accordance with the indicator in response to the second trigger operation in the battle area comprises:
displaying the apply range in the battle area in response to the dragging operation, gradually reducing a display of the skill control during the dragging operation, and stopping the display of the skill control and displaying the indicator in the battle area when an operation position corresponding to the dragging operation is located within the battle area; and
controlling the virtual object to apply the first target skill in accordance with the indicator in response to the releasing operation.

4. The method according to claim 1, wherein the indicator comprises a circular indicator, a radial indicator, or a sector indicator.

5. The method according to claim 4, wherein the indicator is the circular indicator if the first target skill is a range-applied skill.

6. The method according to claim 5, wherein the controlling the virtual object to apply the first target skill in accordance with the indicator comprises:
controlling the virtual object to apply the first target skill to a range indicated by the circular indicator.

7. The method according to claim 4, wherein the indicator is the radial indicator or the sector indicator if the first target skill is a direction-applied skill.

8. The method according to claim 7, wherein the radial indicator or the sector indicator extends from a position of the virtual object to an edge of the apply range.

9. The method according to claim 7, wherein the controlling the virtual object to apply the first target skill in accordance with the indicator comprises:
controlling the virtual object to apply the first target skill to a range indicated by the radial indicator or the sector indicator.

10. The method according to claim 1, comprising marking affected objects corresponding to the first target skill and located in the apply range with a first marker.

11. The method according to claim 1, comprising marking affected objects corresponding to the first target skill and located in a range indicated by the indicator with a second marker.

12. The method according to claim 11, wherein the controlling the virtual object to apply the first target skill in accordance with the indicator comprises:
controlling the virtual object to apply the first target skill to the affected objects marked with the second marker.

13. The method according to claim 1, further comprising:
stopping the display of the apply range and the indicator if determining that an operation position corresponding to the second operation is located outside the battle area.

14. The method according to claim 1, further comprising:
removing the skill control from the control display area if determining that an operation position corresponding to the second operation is located outside the battle area.

15. The method according to claim 1, further comprising:
acquiring current battle data, wherein the current battle data comprises a set of battle data of the virtual object and a set of battle data of an enemy virtual object corresponding to the virtual object; and
increasing or decreasing a proportion of the object display area to the battle area according to the current battle data.

16. The method according to claim 1, wherein the method further comprises:
displaying a resource identifier in the virtual scene, wherein the resource identifier is configured to represent at least one of an upper limit of the resource value, a deducted resource value, and a recovery rate of the resource;
wherein the recovery rate of the resource increases with a time length of the current battle, and/or the recovery rate of the resource increases in a target stage of the battle.

17. The method according to claim 1, wherein the displaying the skill control in the control display area where the object control is placed comprises:
displaying at least one skill control in the control display area;
wherein the displaying, in response to the second operation on the skill control, the apply range and the indicator of the first target skill corresponding to the skill control in the battle area, and controlling the virtual object to apply the first target skill in accordance with the indicator comprises:
obtaining a type of the skill control in response to the second operation on the skill control;
displaying the apply range and the indicator of the first target skill corresponding to the skill control in the battle area, and controlling the virtual object to apply the first target skill in accordance with the indicator if the type of the skill control is determined to be a first type, wherein the first type skill control is configured to apply skills to an enemy virtual object or a teammate virtual object corresponding to the virtual object; and
applying a second target skill corresponding to the skill control to the virtual object if the type of the skill control is determined to be a second type, wherein the second type skill control is configured to apply skills to the virtual object.

18. An electronic device, comprising:
one or more memories; and
one or more processors;
wherein one or more programs are stored in one or more memories, when the one or more programs are executed by the one or more processors, the following steps are implemented:
displaying, in response to a first operation on an object control in a virtual scene, a virtual object corresponding to the object control in an object display area in a battle area of the virtual scene, and displaying a skill control in a control display area where the object control is placed; and
displaying, in response to a second operation on the skill control, an apply range and an indicator of a first target skill corresponding to the skill control in the battle area, and controlling the virtual object to apply the first target skill in accordance with the indicator, wherein the indicator is configured to indicate an action range of applying the first target skill, and the action range of the first target skill is adjustable based on an operation instruction.

19. A computer-readable storage medium, wherein a computer program is stored in the computer-readable storage medium, when the computer program is executed by at least one processor, the following steps are implemented:
displaying, in response to a first operation on an object control in a virtual scene, a virtual object corresponding to the object control in an object display area in a battle area of the virtual scene, and displaying a skill control in a control display area where the object control is placed; and
displaying, in response to a second operation on the skill control, an apply range and an indicator of a first target skill corresponding to the skill control in the battle area, and controlling the virtual object to apply the first target skill in accordance with the indicator, wherein the indicator is configured to indicate an action range of applying the first target skill, and the action range of the first target skill is adjustable based on an operation instruction.

20. (canceled)
